(19) United States
(12) Patent Application Publication
(10) Pub. No.: US 2015/0087228 A1
(43) Pub. Date: Mar. 26, 2015

(54) COEXISTENCE BETWEEN NFC AND WCT

(71) Applicants: Shahar Porat, Ha (IL); Gary N. Matos, Portland, OR (US); Adam D. Rea, Lynnwood, WA (US); Ron W. Gallahan, Portland, OR (US)

(72) Inventors: Shahar Porat, Ha (IL); Gary N. Matos, Portland, OR (US); Adam D. Rea, Lynnwood, WA (US); Ron W. Gallahan, Portland, OR (US)

(21) Appl. No.: 14/125,661

(22) PCT Filed: May 24, 2013
(86) PCT No.: PCT/US2013/042635

§ 371 Date: Dec. 12, 2013

(30) Foreign Application Priority Data
Mar. 12, 2013 (US) 61776990

(51) Int. Cl. H04B 5/00

(52) U.S. Cl. CPC H04B 5/0031
USPC 455/41.1

(57) ABSTRACT

Two devices containing NFC radios may use some of the NFC components to permit one device to wirelessly charge a battery in the other device. Time sharing between the communication and charging, functions may allow the two devices to use the same frequency for both functions, without the charging, function causing interference in the communication function. One device may periodically transmit polls, with both a data exchange communication period and a charging period occurring between two successive polls. In some embodiments, a data exchange period using the NFC radios and a charging period using the charging circuitry do not overlap in time.

### CROSS REFERENCE TO RELATED APPLICATIONS

This patent application is derived from U.S. provisional patent application 61/776,990, filed Mar. 12, 2013, and claims priority to that filing date for all applicable subject matter.

### BACKGROUND

Wireless charging technology (WCT) has been increasingly used as a way to charge the batteries in portable devices, without the need for cables and/or physical connectors. The wireless frequency band used for this purpose is generally the industrial, scientific, and medical frequency band of 13.56 MHz. This same frequency band has also been commonly used for very short-range communication using Near Field Communication (NFC) technology.

Unfortunately, when the two functions are combined into a single device, the charging signal can cause interference with the communication function, and the high transmission power used for charging may even cause damage to the NFC receiver in the device being charged. Attempts have been made to use a different frequency for charging, but this requires additional circuitry in both devices, thereby increasing both the cost and complexity of those devices.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a diagram of a host device and a mobile device, according to an embodiment of the invention.

FIG. 2 shows a block diagram of the internal components of two devices in a WCT/NFC system, according to an embodiment of the invention.

FIG. 3 shows a timing diagram of cycles for polling, exchanging data, and charging, according to an embodiment of the invention.

FIG. 4 shows a flow diagram of a method performed by a host device, according to an embodiment of the invention.

FIG. 5 shows a flow diagram of a method performed by a mobile device, according to an embodiment of the invention.

### DETAILED DESCRIPTION

In the following, description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used, it should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”. “second”, “third”, etc., to describe a common element, merely indicate that different instances of like elements are being referred to, and are not intended to imply that the elements so described must be in a given sequence, either temporally, spatially, in ranking, or in any other manner.

Discussions herein utilizing terms such as, for example, “processing”, “computing”, “calculating”, “determining”, “establishing”, “analyzing”, “checking”, or the like, may refer to operation(s) and/or process(es) or a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “wireless” may be used to describe circuits, devices, systems, methods, techniques, communications channels, etc., that communicate data and/or energy by using electromagnetic radiation through a non-solid medium. A wireless device may comprise at least one antenna, at least one radio, at least one memory, and at least one processor, where the radio(s) transmits signals through the antenna that represent data and receives signals through the antenna that represent data, while the processor(s) may process the data to be transmitted and the data that has been received. The processor(s) may also process other data which is neither transmitted nor received.

As used within this document, the term “communicate” (and its derivatives) is intended to include transmitting and/or receiving data. Similarly, the bidirectional exchange of data between two wireless devices (both devices transmit and receive during the exchange) may be described as ‘communicating’. The term ‘data exchange’ may also be used to denote a communication.

In various embodiments, the same frequency band may be used fir both wireless communicating and wireless charging by alternating between the two functions in a time-sharing manner.

For convenience, in the following description a host device (HD) is described as the device that contains the charging transmitter, while a mobile device (MD) is described as the device that contains the battery to be charged. However, the terms HD and MD are presented merely as examples, and any feasible devices may be used that provide the described, functionality. For example, the host device may be a personal computer, while the mobile device may be a smart phone, but these are also only examples.

For NFC functionality, the HD may periodically transmit an NFC polling signal at defined intervals. In one embodiment, the polling signal may be transmitted every 400 milliseconds (ms), though other intervals may be used. If the HD receives no response to the poll, indicating no other NFC device is within range, it may wait until the start of the next polling interval to transmit another polling signal. In some embodiments, the polling interval may be increased or decreased depending on how often a response is received.

If the HD receives a response from an MD, it may establish an NFC communication link with the MD, and exchange data with the MD for a period of time over the NFC link. Various durations for the data exchange period may be used. In one embodiment, the duration may be fixed and predetermined. In another embodiment, the data exchange period may continue until the desired data has been exchanged, or until another poll is scheduled to be transmitted, whichever occurs first. If more data remains, it may be communicated in one or more subsequent poll intervals. In still another embodiment, the host device may determine the length of the data exchange period for the current and/or a future poll interval, and communicate that information to the mobile device during the current data exchange. Whatever duration is chosen for the data exchange, some or all of the remainder of the polling interval (if any remains) may be devoted to the charging period. For example, a data exchange lasting 50 ms may leave almost 350 ms to be used as a charging period during the current polling interval.

For WCT functionality, the HD may transmit a charging signal between successive polls, during the time when it is not communicating NFC signals. In some embodiments, this charging signal may be much stronger than the polling and/or data exchange signals. The charging signal may start shortly after the completion of a data exchange, and continue until shortly before the next poll. In this manner, the charging signal may be transmitted during those portions of a polling interval when no NFC signals are being transmitted or received, thus avoiding the interference that might otherwise occur. In some embodiments, the MD may be configured to use at least part of the energy received in the data exchange to charge up the battery. However, for the purposes of this document, any such energy received during the data exchange period is not considered part of the charging signal.

It could be a waste of energy to transmit a charging signal when there is no device to be charged, so various methods may be used to initiate the charging signal only when a device is present to be charged. If no device is present, or if a device is present but does not need a battery charge, the charging signal may be eliminated, but the NFC polling may continue.

Because a charging signal might be strong enough to damage the components of an NFC receiver (especially in older, legacy NFC devices), in some embodiments the HD may communicate to the MD during the data exchange that the MD is to turn off any NFC circuits that could be damaged by the charging signal during the charging period, thereby protecting such circuits from damage by the charging signal. The MD may subsequently enable those circuits in time to receive the next poll signal.

In some embodiments, the data exchange may communicate whether an MD is in place to receive a charging signal, and/or whether the device is enabled to receive a charging signal. In some embodiments, the data exchange may communicate a request from the MD to be HD to transmit a charging signal.

In some embodiments, the two devices may communicate information during the data exchange that may affect the specifics of the charging signal. For example, this information may include indicators pertaining to one or more of the following items: 1) whether a charging signal is to be transmitted, 2) the strength of the charging signal, 3) the start time of the charging signal, 4) the duration of the charging signal, 4) whether the charging signal should be adjusted, 5) the charge state of the battery, 6) an internal temperature of the device, 7) the received power of the charging signal, or 8) other charging-related information.

In some embodiments, the MD may be able to communicate us ability to withstand a strong signal, thus approving the use of a stronger charging signal. The HD may then increase the transmitted power in the charging signal. If no such ability is communicated, the HD may assume the MD's NFC circuits cannot withstand such a stronger charging is signal, and limit the charging signal accordingly. In some embodiments, if the HD does not receive an indication of what level of charging signal that the MD is able to withstand, the HD may refuse to transmit any charging signal. In some embodiments, if the HD receives an indication that a second MD has been moved into charging range while a first MD is already being charged, the HD may reduce or eliminate the charging signal based on what information it receives (or does not receive) from the second MD about its ability to withstand a charging signal. Once the second MD is moved out of charging range, the HD may resume the charging signal based solely on the first MD.

In some embodiments, the frequency used for the data exchange signal and the frequency used for the charging signal may be the same, or may be very close in frequency. In some embodiments this frequency may be 13.56 MHz.

Specific features and embodiments are described in the following paragraphs, which are further supported by the accompanying figures.

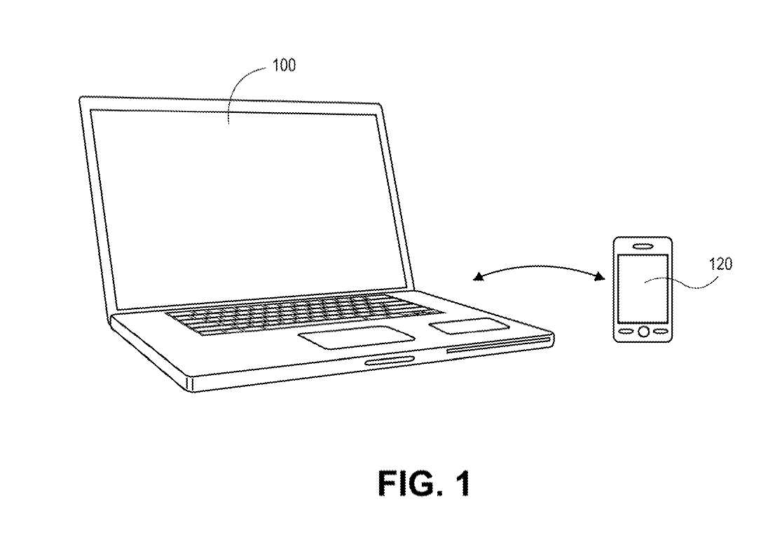

FIG. 1 shows a diagram of a host device and a mobile device, according to an embodiment of the invention. Host device 100 is illustrated as a laptop computer, although any other type of suitable device may be used, such as but not limited to a tablet computer, a desktop computer, or any other type of device that is capable of NFC communications and that has a power source strong enough to provide a wireless charging signal. Mobile device 120 is shown as a smart phone, although any other type of suitable device may be used, such as but not limited to another type of cell phone, a wireless memory device, or any other type of device that is capable of NFC communication and that has a battery to be charged wirelessly.

Each device may have a particular location where its NFC antenna is located, and these locations may determine how the two devices are oriented with respect to each other for NFC communication and battery charging, in some embodiments, the mobile device may be placed next to a particular location of the host device. In other embodiments, the mobile device may be placed onto a particular location of the host device, such as (but not limited to) a designated area of the keyboard surface. In still other embodiments, the host device may have a sliding shelf that extends to hold the mobile device. Other configurations may also be used.

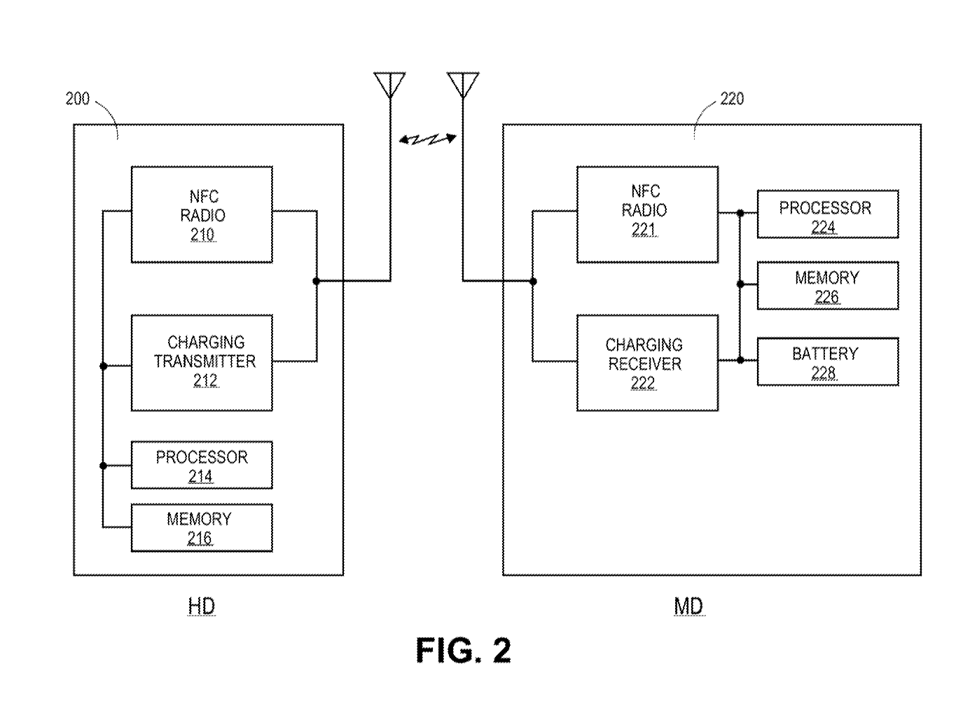

FIG. 2 shows a block diagram of the internal components of two devices in a WCT/NFC system, according to an embodiment of the invention. Host device 200 is shown with a processor 214 and a memory 216, as well as an NFC radio 210 to provide NFC communications. A charging transmitter 212 is also shown, containing circuitry to create and control a wireless charging signal. Both the NFC radio and the charging transmitter are shown as using the same antenna, although in some embodiments each may have its own separate antenna. Although shown as two separate items, in some embodiments the NFC radio 210 and charging transmitter 212 may share some common components.

Mobile device 220 is shown with a processor 224, memory 226, and NFC radio 221. It is also shown with a battery 228 to provide electrical power to the processor and memory. In some embodiments the battery may also provide power to the NFC radio, while in other embodiments the NFC radio may obtain part or all of its operating power from the signals received through its antenna. Mobile device 220 is also shown with a charging receiver 222, which may obtain electrical power from the charging signals received through the antenna, and use that power to recharge battery 228. Both the NFC radio and the charging receiver are shown as using the same antenna, although in some embodiments each may have its own separate antenna. Although shown as two separate items, in some embodiments the NFC radio 221 and charging receiver 222 may share some corm On components.

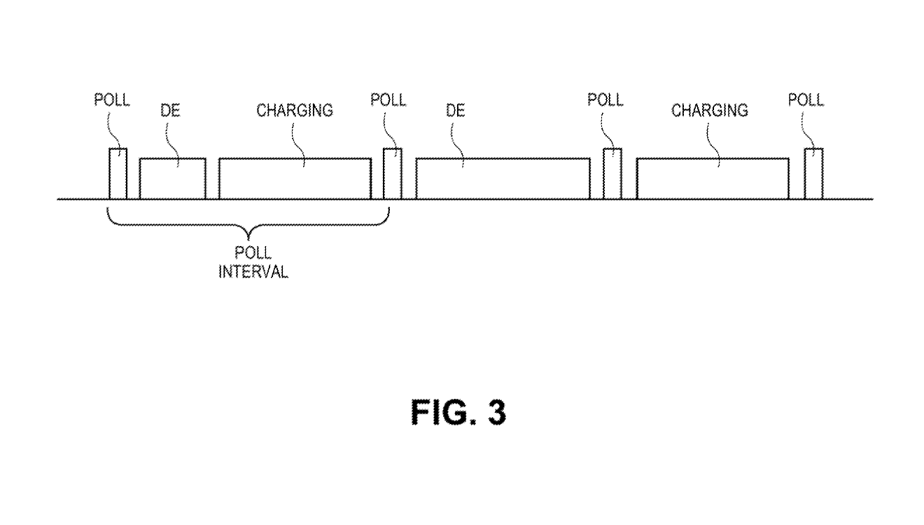

FIG. 3 shows a timing diagram of cycles for polling, exchanging data, and charging, according to an embodiment of the invention. The illustrated diagram shows a series of polls transmitted at intervals that are descriptively labeled as poll intervals. The period of time labeled as ‘Poll’ in this diagram may include the time to transmit a poll, and may also include a pre-determined time to receive one or more responses to the poll. If a response to the poll is received within that time, the poll period may be followed by a data exchange (DE) period, during which the polling device and the responding device may communicate with each other over their NFC radios. Once the data exchange period is over, all or part of the remaining time in the polling interval may be devoted to charging. In one embodiment, the data exchange period and the charging period do not overlap in time.

The illustrated example of FIG. 3 shows three polling intervals. The first includes both a data exchange period and a charging period. The second includes a data exchange period but no charging period. This may occur when the device responding to the poll is not configured to be charged in this manner, or indicates it has no need for a charging signal. The third interval has a charging period but no data exchange period. The lack of a data exchange period may be caused when the device(s) that respond to the poll indicate they have no data to exchange. However, some embodiments may always include a data exchange period, even if it's only to exchange information defining the charging signal and duration. Although the examples show the data exchange period occurring before the charging period in each polling interval, in some embodiments the charging interval may is occur first, with the data exchange period occurring next.

Of course, if no device is detected as being present, both the data exchange and charging periods may be eliminated, and only the polling periods will remain so that the host device can periodically determine if another NFC device is within range.

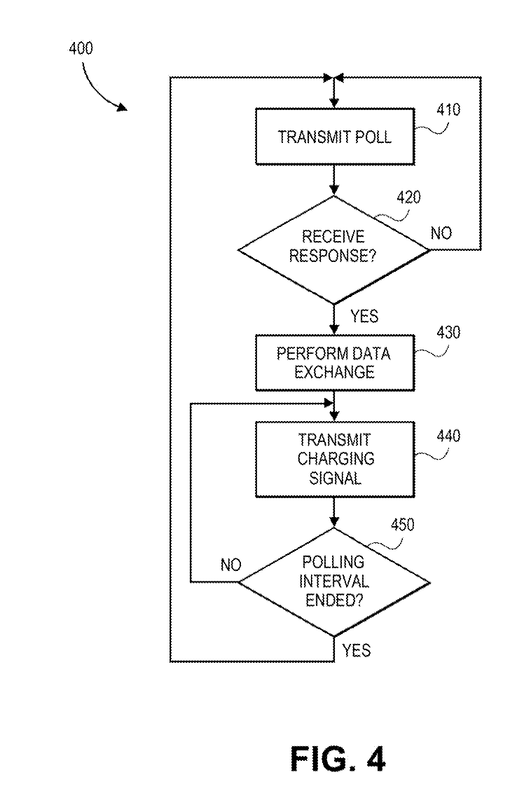

FIG. 4 shows a flow diagram of a method performed by a host device, according to an embodiment of the invention. In flow diagram 400, the host device may transmit a polling signal through its NFC radio at 410. If a response is not received within the designated time, the host device may wait for a polling interval and then transmit another poll. However, if a response is received, as determined at 420, it may execute an NFC data exchange with the responding device at 430 (where ‘NFC data exchange’ means the two devices use their NFC radios to communicate with each other). When the data exchange period is over, the host may transmit a charging signal at 440 until the polling interval ends at 450, and then start again by transmitting another polling signal at 410. Although not shown in this flow diagram, the duration of the data exchange period and/or the charging period may be fixed or may vary, depending on various factors previously described.

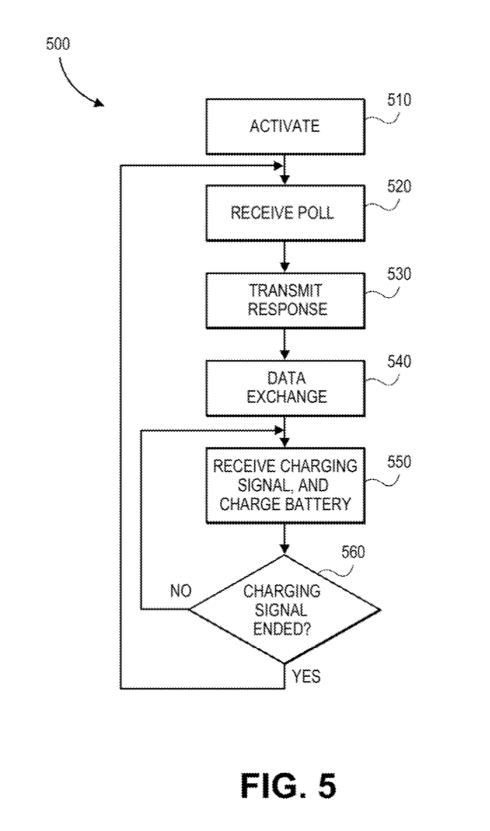

FIG. 5 shows a flow diagram of a method performed by a mobile device, according to an embodiment of the invention. In flow diagram 500, the NFC circuits of the mobile device may be activated at 510. In some embodiments, the NFC circuits may be activated when a received NFC signal provides enough energy through the antenna to power up the NFC activation circuits. In other embodiments, the NFC circuits may already be active in a listening mode.

When an NFC poll is received from a host device at 520, the mobile device may identify its presence to the host device by transmitting an NFC response at 530. This may be followed by executing an NFC data exchange at 540, during which the two devices may communicate various information with each other through their NFC radios. Following the data exchange period, the mobile device may receive a charging signal from the host device at 550, and use the energy from that charging signal to charge up its battery. When the charging signal ends at 560, the flow may return to 520 to await another polling signal. If the mobile device is physically removed from its communication/charging position, then it may be out of range for the polling signal, data exchange signal, and charging signal, and the operations of FIG. 5 may cease.

### EXAMPLES OF VARIOUS EMBODIMENTS

A first example includes a method of wireless communication comprising transmitting an NFC poll signal at predetermined intervals, and performing, after each poll signal: listening for an NFC response from a second wireless communication device, executing an NFC data exchange with the second device if the response is received, transmitting a charging signal, and stopping the transmitting of the charging signal before another NFC poll signal is scheduled to occur, wherein the NFC data exchange and the charging signal do not overlap in time.

A second example includes the first example, wherein a duration of the NFC data exchange is fixed.

A third example includes the first example, wherein a duration of the NFC data exchange is variable, and the duration is indicated in a current or previous data exchange.

A fourth example includes the first example, wherein the data exchange includes information on a charge state of a battery in another device participating in the data exchange.

A fifth example includes the first. example, wherein the data exchange includes information pertaining to one or more of the following items 1) whether a charging signal is to be transmitted, 2) a strength of the charging signal, 3) a start time of the charging signal, 4) a duration of the charging signal, 4) whether the charging signal should be adjusted, 5) a charge state of the battery, 6) an internal temperature of the device, and 7) a received power of the charging signal.

A sixth example includes the first example, wherein the data exchange signal and the charging signal use a same frequency.

A seventh example includes a first wireless communications device having a processor, a memory, and a near field communication (NFC) radio, the first device adapted to perform the method of the first through sixth examples.

A seventh example includes a first wireless communications device having a processor, a memory, and a near field communication (NFC) radio, the first device adapted to perform the method of the first through sixth examples.

An eighth example includes a computer-readable non-transitory storage medium that contains instructions, which when executed by one or more processors result in performing operations comprising the method of the first through sixth examples.

A ninth example includes a method of communicating wirelessly, comprising: performing an NFC data exchange with a wireless communication device and receiving a charging signal from the wireless communication device, wherein the data exchange and the charging signal occur between two successive polls from the wireless communication device, and wherein the data exchange and the chaining signal do not overlap in time.

A tenth example includes the ninth example, wherein a duration of the NFC data exchange is fixed.

An eleventh example includes the ninth example, wherein a duration of the NFC data exchange is variable, and the duration is indicated in a current or previous data exchange.

A twelfth example includes the ninth example, wherein the data exchange includes information pertaining to one or more of the following items: 1) whether a charging signal is to be transmitted, 2) a strength of the charging signal, 3) a start time of the charging signal, 4) a duration of the charging signal, 4) whether the chaining signal should be adjusted, 5) a charge state of a battery, 6) an internal temperature of the device, and 7) a received power of the charging signal.

A thirteenth example includes the ninth example, wherein the data exchange signal and the charging signal use a same frequency.

A fourteenth example includes a first wireless communication device having a processor, a memory, and a near field communication (NFC) radio, the first device adapted to perform the method of the ninth through thirteenth examples.

A fifteenth example includes a computer-readable non-transitory storage medium that contains instructions, which when executed by one or more processors result in performing operations comprising the method of the ninth through thirteenth examples.

The foregoing description is intended to be illustrative and not limiting. Variations will occur to those of skill in the art. Those variations are intended to be included in the various embodiments of the invention, which are limited only by the scope of the following claims.

What is claimed is:

1. A first wireless communications device having a processor, a memory, and a near field communication (NFC) radio, the first device adapted to
transmit an NFC poll signal at predetermined intervals; and
perform, after each poll signal:
listening for an NFC response from a second wireless communication device:
executing an NFC data exchange with the second device if the response is received;
transmitting a charging signal; and
stopping, the transmitting of the charging signal before another NFC poll signal is scheduled to occur;
wherein the NFC data exchange and the charging signal do not overlap in time.

2. The first device of claim 1, wherein a duration of the NFC data exchange is fixed.

3. The first device of claim 1, wherein a duration of the NFC data exchange is variable, and the duration is indicated in a current or previous data exchange.

4. The first device of claim 1, wherein the data exchange includes information pertaining to one or mote of the following items: 1) whether a charging signal is to be transmitted, 2) a strength of the charging signal, 3) a start time of the charging signal, 4) a duration of the charging signal, 4) whether the charging signal should be adjusted, 5) a charge state of a battery, 6) an internal temperature of the second device, and 7) a received power of the charging signal.

5. The first device of claim 1, wherein the data exchange signal and the charging signal use a same frequency.

6. A method of wireless communication by a first wireless device, comprising:
transmitting an NFC poll signal at predetermined intervals; and
performing after each poll signal:
listening; for an NFC response from a second wireless communication device;
executing an NFC data exchange with the second device if the response is received;
transmitting a charging signal; and
stopping the transmitting of the charging signal before another NFC poll signal is scheduled to occur;
wherein the NFC data exchange and the charging signal do not overlap in time.

7. The method of claim 6, wherein a duration of the NFC data exchange is fixed.

8. The method of claim 6, wherein a duration of the NFC data exchange is variable, and the duration is indicated in a current or previous data exchange.

9. The method of claim 6, wherein the data exchange includes information on a charge is state of a battery in another device participating in the data exchange.

10. The method of claim 6, wherein the data exchange includes information pertaining to one or more of the following items: 1) whether a charging signal is to be transmitted, 2) a strength of the charging signal, 3) a start time of the charging signal, 4) a duration of the charging signal, 4) whether the charging signal should be adjusted, 5) a charge state of the battery, 6) an internal temperature of the second device, and 7) a received power of the charging signal.

11. The method of claim 6, wherein the data exchange signal and e charging signal use a same frequency.

12. A computer-readable non-transitory storage medium that contains instructions, which when executed by one or more processors result in performing operations comprising:
transmitting an NFC poll signal from a first device at predetermined intervals; and
performing, after each poll signal:
listening for an NFC response from a second wireless communication device;
executing an NFC data exchange with the second device if the response is received;
transmitting a charging signal; and
stopping the transmitting of the charging signal before another NFC poll signal is scheduled to occur;
wherein the NFC data exchange and the charging, signal do not overlap in time.

13. The medium of claim 12, wherein a duration of the NFC data exchange is fixed.

14. The medium of claim 12, wherein a duration of the NFC data exchange is variable. and the duration is indicated in a current or previous data exchange.

15. The medium of claim 12, wherein the data exchange includes information on a charge state of a battery in another device participating in the data exchange.

16. The medium of claim 12, wherein the data exchange includes information pertaining to one or more of the following items: 1) whether a charging signal is to be transmitted, 2) a strength of the charging signal, 3) a start time of the charging signal, 4) a duration of the charging signal, 4) whether the charging signal should be adjusted, 5) a charge state of a battery, 6) an internal temperature of the second device, and 7) a received power of the charging signal.

17. A first wireless communication device having a processor, a memory, and a near Field communication (NFC) radio, the first device adapted to:
perform an NFC data exchange with a second wireless communication device; and
receive a charging signal from the second device;
wherein the data exchange and the charging signal occur between two successive polls from the second device;
wherein the data exchange and the charging signal do not overlap in time.

18. The first device of claim 17, wherein a duration of the NFC data exchange is fixed.

19. The first device of claim 17, wherein a duration of the NFC data exchange is variable, and the duration is indicated in a current or previous data exchange.

20. The first device of claim 17, wherein the data exchange includes information pertaining to one or more of the following items: 1) whether a charging signal is to be transmitted, 2) a strength of the charging signal, 3) a start time of the charging signal, 4) a duration of the charging signal, 4) whether the charging signal should be adjusted, 5) a charge state of a battery, 6) an internal temperature of the first device, and 7) a received power of the charging signal.

21. The first device of claim 17, wherein the data exchange signal and the charging signal use a same frequency.

22. A method of communicating wirelessly by a first device, comprising:
performing an NFC data exchange with a second wireless communication device; and
receiving a charging signal from the second wireless communication device;
wherein the data exchange and the charging signal occur between two successive polls from the second wireless communication device;
wherein the data exchange and the charging signal do not overlap in time.

23. The method of claim 22, wherein a duration of the NFC data exchange is fixed.

24. The method of claim 22, wherein a duration of the NFC data exchange is variable, and the duration is indicated in a current or previous data exchange.

25. The method of claim 22, wherein the data exchange includes information pertaining to one or more of the following items: 1) whether a charging signal is to be transmitted, 2) a strength of the charging signal, 3) a start time of the charging signal, 4) a duration of the charging signal, 4) whether the charging signal should be adjusted, 5) a charge state of a battery, 6) an internal temperature of the first device, and 7) a received power of the charging signal.

26. The method of claim 22, wherein the data exchange signal and the charging signal use a same frequency.

27. A computer-readable non-transitory storage medium that contains instructions, which when executed by one or more processors result in performing operations comprising:
performing an NFC data exchange with a wireless communication device; and
receiving a charging signal from the wireless communication device;
wherein the data exchange and the charging signal occur between two successive polls from the wireless communication device;
wherein the data exchange and the charging signal do not overlap in time.

28. The medium of claim 27, wherein a duration of the NFC data exchange is fixed.

29. The medium of claim 27, wherein a duration of the NFC data exchange is variable, and the duration is indicated in a current or previous data exchange.

30. The medium of claim 27, wherein the data exchange includes information pertaining to one or more of the following items: 1) whether a charging signal is to be transmitted, 2) a strength of the charging signal, 3) a start time of the charging signal, 4) a duration of the charging signal, 4) whether the charging signal should be adjusted, 5) a charge state of the battery, 6) an internal temperature of a device, and 7) a received power of the charging signal.
